(19) United States
(12) Patent Application Publication
(10) Pub. No.: US 2013/0251172 A1
(43) Pub. Date: Sep. 26, 2013

(54) Inflatable Ear Buds

(71) Applicant: Jack Mosseri, Brooklyn, NY (US)

(72) Inventor: Jack Mosseri, Brooklyn, NY (US)

(21) Appl. No.: 13/848,711

(22) Filed: Mar. 21, 2013

Related U.S. Application Data
(60) Provisional application No. 61/613,717, filed on Mar. 21, 2012.

(51) Int. Cl. H04R 1/10

(52) U.S. Cl. CPC H04R 1/10
USPC 381/74

(57) ABSTRACT

A wearable sound emitting device comprises a speaker, an audio circuit configured to generate sound from a media device, an inflatable, flexible mount comprising an exterior surface and an interior surface, wherein at least one conduit between said interior surface and said exterior surface permits transmission of a fluid, means to inflate said mount and a housing configured to receive at least a portion of said exterior surface of said mount and configured to receive said means to inflate said mount, wherein said housing couples said speaker to said audio circuit and couples said conduit of said mount to said means to inflate said mount.

### RELATED APPLICATIONS

This application claims the benefit of U.S. Provisional Patent Application Ser. No. 61/613,717 filed Mar. 21, 2012, the entire disclosures of which are hereby incorporated by reference in this application in their entirety.

### FIELD OF THE INVENTION

Disclosed are embodiments of the invention which relate to, among other things, inflation mechanisms for earphones and other wearable speaker devices.

### BACKGROUND

Headphones, earphones and ear buds are among the various names given to speaker systems worn by individuals to transmit sound signals produced by or in a media device, translate the signals into audible sounds, and project sounds in or around the ear canals of the user.

Sounds from head phones and ear buds are produced from audio circuitry within the device and are channeled through a speaker into the area between the speaker and the user's ear, e.g., a sound cavity. Ideally, the sounds produced from the speaker would all enter the user's ear canal without disruption, interference or other sound losses within the sound cavity. One potential cause of such sound loss is intermittent or permanent vacancies between the speaker and the user's ear such that the sound cavity is not closed.

When the headphone or ear bud speaker is not in substantially close contact with the user's ear, sound can escape from the sound cavity, resulting in noise, interference and loss of quality of the media projected.

In active environments, a headphone or ear bud's capacity to remain in place within the sound cavity may also be compromised if the headphone or ear bud speaker cannot maintain or continue to maintain substantially close contact with the user's ear.

Therefore, there is a need for headphone, ear bud or other forms of wearable speaker systems to better establish the advantageous close contact with the user's ear to avoid sound losses in various environments and to stay lodged in the user's ear without falling out.

### SUMMARY OF THE INVENTION

In one exemplary embodiment of the present invention, a wearable sound emitting device comprises a speaker, an audio circuit configured to generate sound from a media device, and an inflatable, flexible mount comprising an exterior surface and an interior surface, wherein at least one conduit between the interior surface and the exterior surface permits transmission of a fluid. Mechanisms to inflate the mount may be disposed within a housing configured to receive at least a portion of the exterior surface of the mount and configured to receive one or more mechanisms to inflate the mount. The housing further couples the speaker to the audio circuit and further couples the conduit of the mount to the inflation mechanisms.

In another exemplary embodiment of the present invention, a wearable sound emitting device comprises a speaker, an audio circuit configured to generate sound from a media device, an inflatable, flexible mount comprising an exterior surface and an interior surface with at least one conduit between said interior surface and said exterior surface which permits transmission of a fluid. Mechanisms to inflate the mount may be coupled to the conduit. A housing configured to receive at least a portion of the exterior surface of the mount also couples the speaker to the audio circuit.

In another exemplary embodiment of the present invention an inflatable mount may revolve substantially or completely about the surface of a housing for a wearable sound emitting device. Such an inflatable mount may be rectangular or circular in cross-section. Alternatively such an inflatable mount may be any shape for achieving sufficient contact with the ear of a user.

In another exemplary embodiment, mechanisms to inflate or deflate the mount may be one or more of the following: flexible latches, rolling channels, removable or anchored plugs, sliding openings, spring-action latches, unidirectional flow valves, flexible pumps, or bulbous pump housings. Those skilled in the art would understand other suitable mechanisms to accomplish the inflation or deflation of the inflatable mount.

In another exemplary embodiment, mechanisms to inflate or deflate the mount may be found exclusively on a surface of the mount, within the housing, on a surface of the housing or any combination thereof.

In another exemplary embodiment, inflatable mount may inflate to accommodate spaces in or around the ear of a user. An inflatable mount according to the exemplary embodiments of the present invention may occupy a portion of the interior of a user's ear to reduce noise. An inflatable mount according to the exemplary embodiments of the present invention may contact a portion of the interior of a user's ear to reduce interference to sounds generated from a speaker. Alternatively, an inflatable mount according to the exemplary embodiments of the present invention may surround the periphery of a user's ear to reduce noise and/or interference to sounds generated from a speaker.

Alternatively, an inflatable mount according to the exemplary embodiments of the present invention may surround the periphery of a user's ear to remain inside the user's ear and not fall out.

### BRIEF DESCRIPTION OF THE DRAWINGS

FIG. 1 illustrates an exemplary headphone in side-view and front-view, both configured for connection to a media device.

FIGS. 2, 2A and 2B illustrate an ear bud and installation of same on a headphone.

FIGS. 3 and 3A illustrate an exemplary ear bud assembly.

FIG. 4 illustrates an exemplary ear bud and headphone system.

FIGS. 4A, 4B and 4C illustrate exemplary inflation-deflation mechanisms referenced with respect to several exemplary embodiments.

FIG. 5 illustrates a variant of an ear bud and headphone assembly.

FIG. 6 illustrates a variation of an ear bud inflation mechanism.

FIGS. 7, 7A and 7B illustrate an ear bud-headphone system.

FIGS. 8, 8A and 8B illustrate a variant of an ear bud-headphone system.

FIG. 9 illustrates a headset headphone system.

FIGS. 10A and 10B illustrate use of various exemplary embodiments in and around a user's ear.

In the drawings like characters of reference indicate corresponding parts in the different figures.

### DETAILED DESCRIPTION

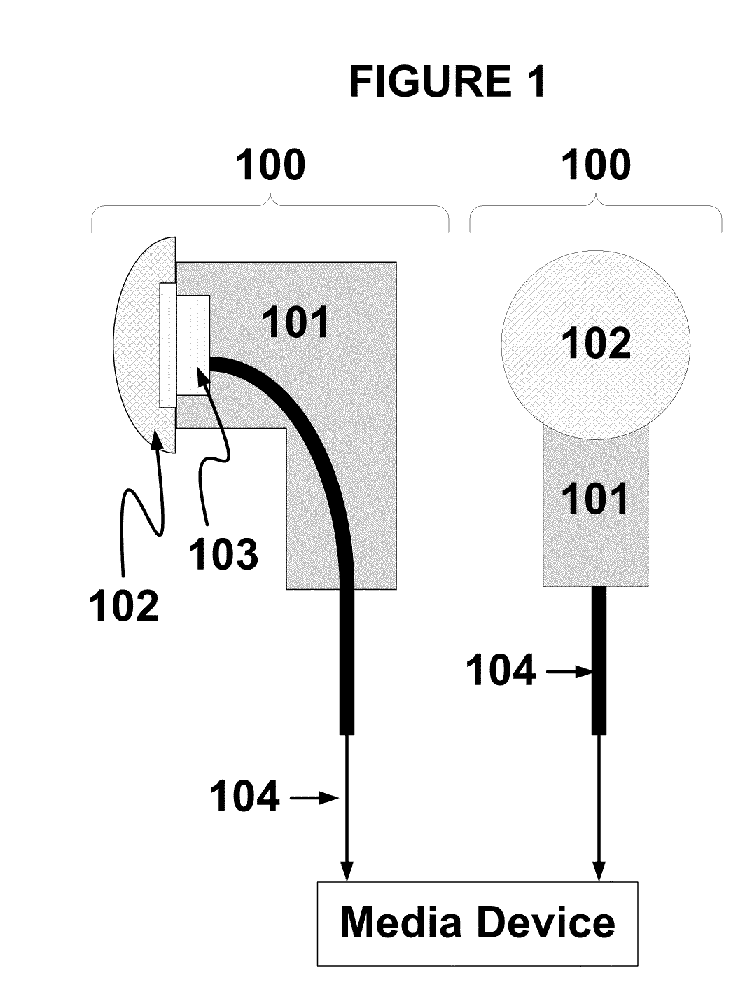

Illustrated in FIG. 1 is a headphone 100 which comprises a housing 101 attached to a speaker 102. Housing 101 and speaker 102 enclose audio circuitry 103 and signal transmission wire or wires 104. Wire 104 connects audio circuitry 103 to a media device (not shown) for transmission of signals from media device to audio circuitry 103. Those skilled in the art would understand that wire 104 is not necessary if audio circuitry 103 communicates wirelessly with the media device. Therefore, the disclosed embodiments are not limited to only wired forms of headphone 100, but contemplate all types known to those skilled in the art.

Audio circuitry 103 may operate in conjunction with speaker 102 to produce sounds according to the signals received from the media device. Headphone 100, housing 101, speaker 102, audio circuitry 103 and wire 104 may be any form or configuration known to those skilled in the art, e.g., in-ear headphones, headphones which wrap around the back of the user's head, over-the-top-of-the-head head phones. For embodiments in which no wire 104 is necessary, those skilled in the art would recognize headphone 100 may be any form of WiFi or Bluetooth device which wirelessly transmits signals from a media device to audio circuitry 103.

A speaker 102 may be made of rubber, plastic or any other form which permits transmission of sound as relayed by audio circuitry 103. Likewise, audio circuitry 103 may be any type, form or configurable set of electronic components suitable to render sound from signal transmissions from a media device, e.g., a compact disc player, Walkman, mp3 Player, iPod or other forms of smart phones/portable digital assistants, laptop, airplane audio jack, cell phone, or wireless forms of the same.

Housing 101 may be made of any form or material known to those skilled in the art of portable electronic devices. For example, housing 101 may be plastic. Where housing 101 is a housing for over-the-top-of-the head headphones, housing 101 may be a composite of metal parts and plastic components. Thus, according to the various embodiments of the present invention, housing 101 may be any moldable or composite device capable of functioning in conjunction with the disclosed systems provided herein.

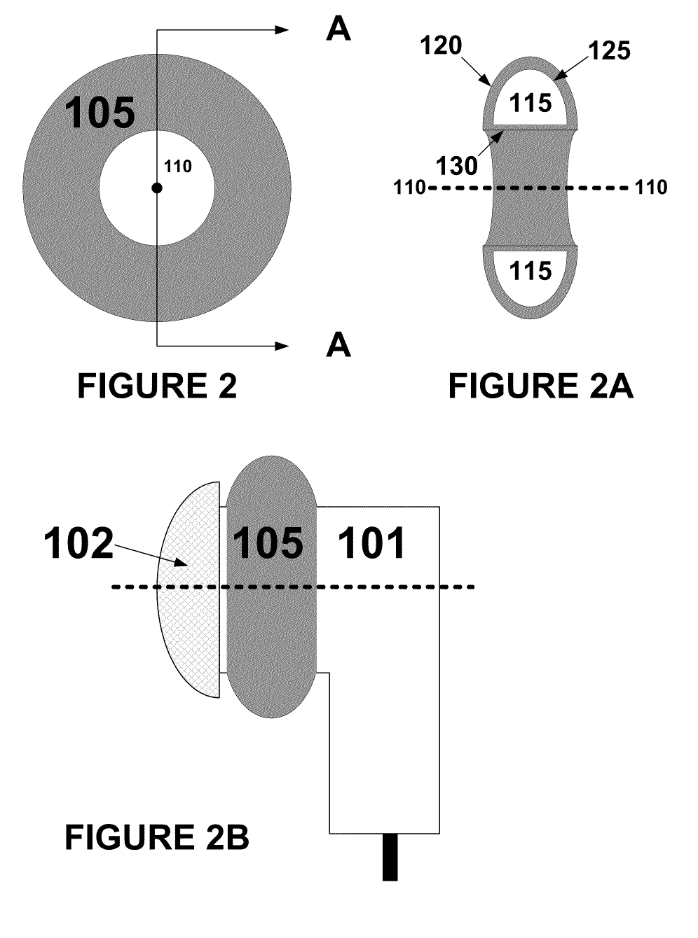

FIG. 2 illustrates an ear bud 105 which may surround an axis 110. An exemplary ear bud 105 may be fabricated from silicone, rubber or other deformable materials. However, a cross section A of ear bud 105, illustrated by FIG. 2A, shows that ear bud 105 may be partially or entirely hollow within its walls. In the illustration of FIG. 2A, peripheral wall 120 and inner wall 125 continuously enclose ear bud channel 115 about axis 110. Although as illustrated peripheral wall 120 and inner wall 125 form a round doughnut-like shape, they may alternatively form boxed shapes, triangular shapes and any other moldable forms known to those skilled in the art. Ear bud 105 may be manufactured from molding processes known to those skilled in the art, e.g., extrusion, rolling, heat binding. An exemplary ear bud channel 115 may be one in which ear bud channel 115 retains substantially the same volume of fluid within its space over time. Alternatively, ear bud channel 115 may be one where in its formation, fluid cannot escape through inner wall 125.

Also illustrated is axial wall 130 of ear bud 105, which may be identical in shape, size and configuration to either of peripheral wall 120 or inner wall 125 or differ depending on the circumstances for which the ear bud will be installed on a headphone 100. For example, axial wall 130 may be configured for frictional fitting between ear bud 105 and housing 101 of headphone 100 or may be adhesively bound to the housing 101 in whole or in part. Axial wall 130 may only partially complete the perimeter of inner wall 125 and/or outer wall 120. For example, axial wall 130 may open up ear bud 105 so that housing 101 and inner wall 125 encompass channel 115. Those skilled in the art will understand that any form of mechanical connection may be achieved between axial wall 130 and a headphone housing 101 so that ear bud channel 115 will be able to substantially retain fluid.

FIG. 2B illustrates another exemplary embodiment of an ear bud 105 affixed to headphone housing 101. Ear bud 105 may be placed in any substantially open space capable of fixation of ear bud 105 to headphone 100. Optionally, ear bud 105 may be located behind speaker 102. Alternatively, ear bud 105 may envelop or partially cover speaker 102. Additionally, ear bud 105 may be configured to both cover speaker 102 and contoured surfaces of housing 101. Those skilled in the art will understand molding processes and binding processes for the manufacture of an ear bud of the types herein disclosed and attachment of the same to various types of headphones, headphone housings and/or headphone speakers.

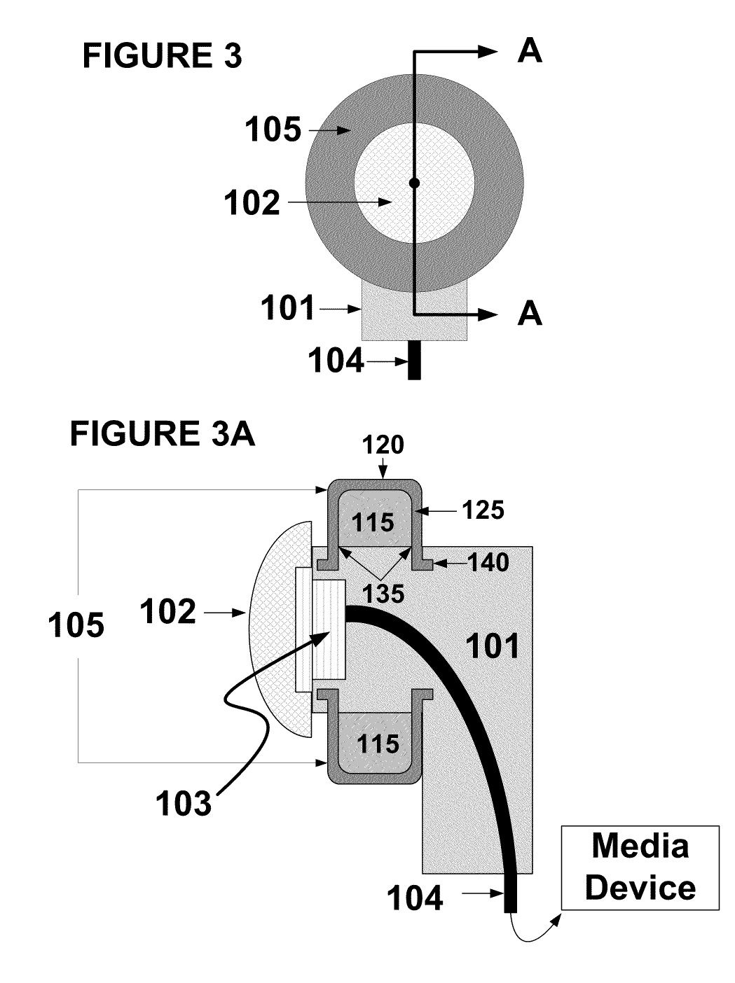

FIG. 3 illustrates an exemplary embodiment of the present invention wherein housing 101 carries ear bud 105 about a portion of housing 101 holding wire 104 and a portion holding speaker 102. Cross section A may be located at the geometric center of the speaker 102, which may or may not be the geometric center of ear bud 105, e.g., depending on the profile of housing 101 to which ear bud 105 conforms. FIG. 3A depicts an exemplary cross section of an exemplary embodiment of the present invention where a housing 101 comprises a speaker 102, audio circuitry 103, wire 104 and a portion of ear bud 105. As illustrated in the exemplary embodiment of FIG. 3A, ear bud 105, comprising an outer surface 120 and inner surface 125, may be embedded within housing 101 by a portion 140 of the ear bud wall defined by outer surface 120 and inner surface 125. In one example, portion 140 may be integrated with housing 101 in any manner which substantially retains fluid within ear bud channel 115. In another example, portion 140 may be friction fitted within housing 101. In a different embodiment, portion 140 may be adhesively bound to housing 101.

In one aspect of the present invention according to the illustrative embodiment of FIG. 3A, housing channel 135 may be shaped, carved-out, or otherwise configured to allow ear bud to be slid into vacant portions of housing 101 to substantially retain fluid occupying ear bud channel 115. Alternatively, housing channel 135 may cooperatively engage ear bud portion 140 to establish a connection which substantially retains fluid within ear bud channel 115. According to the illustrative embodiment of FIG. 3, housing channel 135 may form an “L” shaped cavity about the periphery of housing 101 to engage a complementary shaped “L” portion 140 made of rubber. Portion 140 continues from the “L” shaped cavity in housing 101 and bends towards another “L” shaped cavity in housing 101 into which it provides for yet another complementary “L” shape. Between both portions 140 is a wall defined by inner surface 125 and outer surface 120. A channel 115 exists between the combination of complementary engagements between portions 140 and housing channels 135 and the inner surface 125.

Channels 135 may have been described with respect to housing 101, but nothing in the disclosure should be treated as limiting such constructs to the housing 101 of headphone 100. For example, a set of channels 135 may be formed in housing 101 surface and another set of channels 135 may be in a surface of speaker 102. Thus, the present invention contemplates numerous positioning of channels 135 for receipt of ear bud 105 in accordance with the various aspects of the present invention.

According to an exemplary embodiment of FIG. 3A, the complementary friction engagement between channels 135 and ear bud portions 140 may permit ear bud 105 to be removable from headphone 100. In one aspect of this exemplary embodiment, an ear bud 105 engaged in channels 135 of housing 101 at portions 140 may be squeezed at outer surface 120 and, by doing so, disengage portions 140 from channels 135. Likewise, ear bud 105 may be re-engaged with housing 101 in the opposite fashion. Thus, according to at least certain aspects of the exemplary embodiment illustrated in FIG. 3A, a headphone 100 may be configured to receive and release many types of ear bud 105 according to particular needs and desires of a user, e.g., larger ear bud 105 for larger ears of user, different color ear buds, ear buds having different shapes.

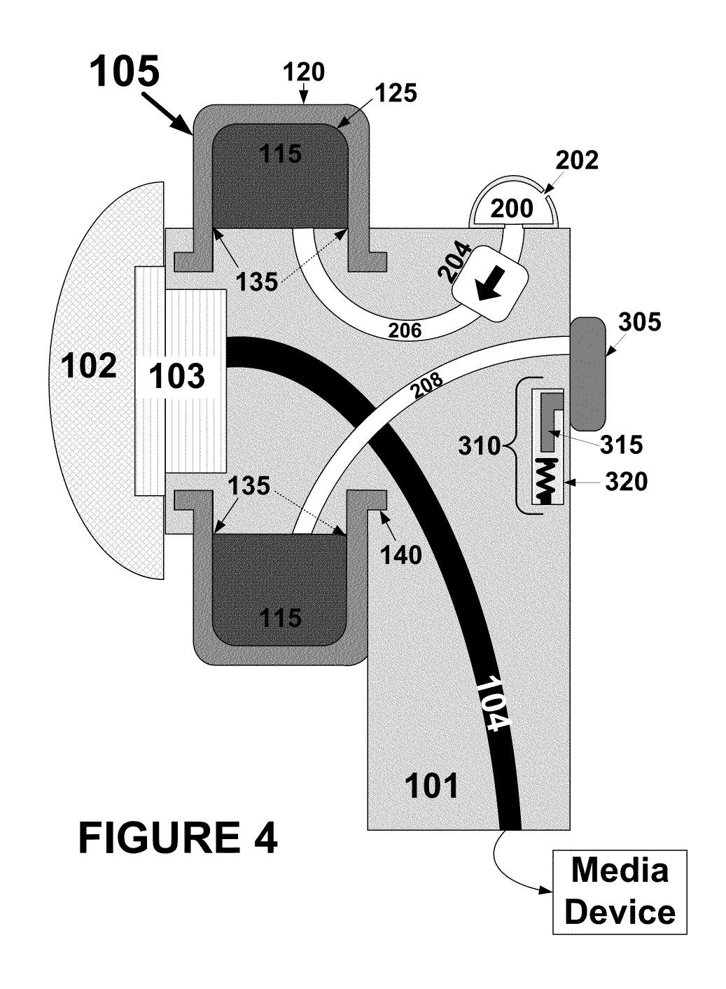

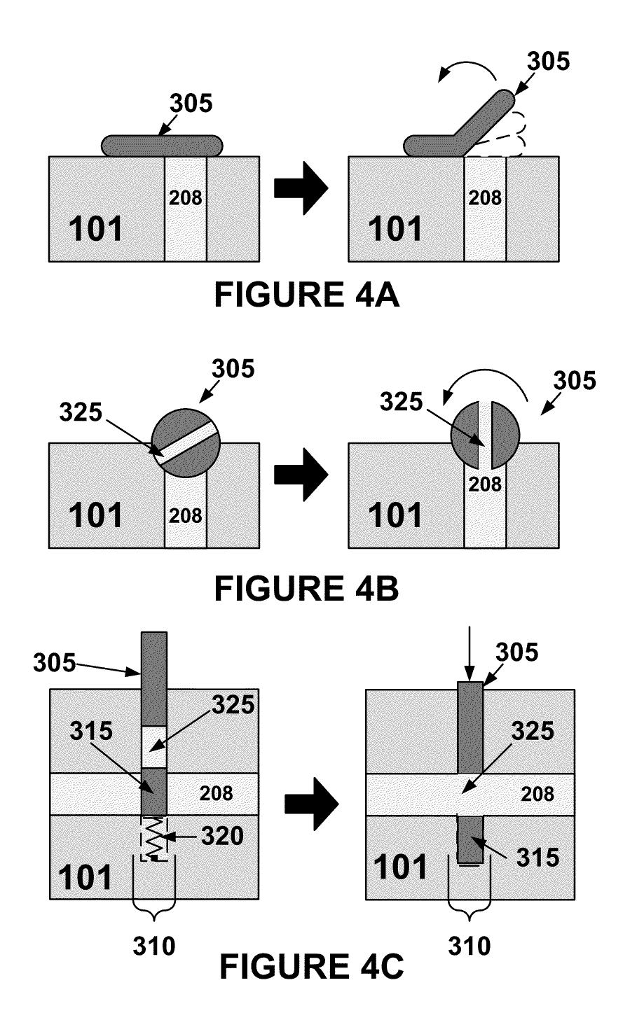

Illustrated in FIG. 4 is yet another exemplary embodiment of the present invention. FIG. 4 depicts housing 101 coupled to audio circuitry 103 which communicates sound to speaker 102. Audio circuitry 103 is coupled to wire 104 which interacts with a media device (not shown). Ear bud 105, having an outer surface 120, an inner surface 125 and portions 140, is coupled to channels 135 of housing 101. The wall defined by outer surface 120 and inner surface 125 surrounds ear bud channel 115.

In one aspect of the exemplary embodiment of FIG. 4, housing 101 may contain a flexible pump 200 coupled to an exterior surface of housing 101 by means known to those skilled in the art (e.g., adhesives, screws, heating, friction fitting). Alternatively, a separable component of housing 101 may contain a flexible pump 200 which component may be operatively connected to or inserted within housing 101 by means known to those skilled in the art. In a different embodiment, pump 200 is an integrated component of housing 101 of headphone 100.

Pump 200 may be any flexible material that undergoes plastic deformation, for example, a rubber or silicone material. Pump 200 contains a passage 202 exposing interior of pump 200 to the ambient. By compressing pump 200, a fluid, e.g., air, located within pump 200 may be moved from the interior of pump 200 through input conduit 206. During this compression action, passage 202 may be precluded from allowing fluid within pump 200 to escape pump 200. Thus, compression of pump 200 forces substantially all fluid therein to be sent into housing 100 via input conduit 206. An exemplary pump 200 may be small enough to fit on housing 101 without interfering with coupling housing 101 with ear bud 105. Alternatively, pump 200 may be separately attached to housing 101 by a user, e.g., screwed into a threaded reception point in housing 101. Optionally, pump 200 may be operated by using a single finger to compress and decompress its surface.

Input conduit 206 may be any molded form or construct within housing 101 communicating a fluid from pump 200 to an ear bud channel 115 formed according to the various embodiments of the present invention. An exemplary input conduit 206 may be formed from a mold use to form housing 101. Alternatively, input conduit 206 may be a separate tubing component within housing 101. In yet another embodiment, input conduit 206 may be a combination of molded parts and tubes. Those skilled in the art will understand how to implement an input conduit 206 in accordance with the various aspects of the present invention.

One-way valve 204 may be located substantially near pump 200 or a portion of conduit 206. One-way valve 204 may be any form of one-way valve known to those skilled in the art, e.g., such as duckbill valves, umbrella valves, minivalve balls, dome valves, Belleville valves and cross-slit valves. The valves may be molded, adhered or otherwise bonded to input conduit 206 in the path of flow of fluid from pump 200 to ear bud channel 115. According to embodiments where input conduit 206 may be a molded form in housing 101, a molded slot for one-way valve 204 may be provided for such that fluid going through input conduit 206 must pass through one-way valve 204. In yet other embodiments, one-way valve 204 may be heat bonded to a tube of input conduit 206 to restrict fluid from reversing flow direction. Once compression of pump 200 forces fluid, e.g., air, through one-way valve 204, the fluid continues to ear bud channel 115. Upon relieving pressure on pump 200, passage 202 once again may open to the ambient for receipt of more fluid within pump 200. In an exemplary embodiment of the present invention, repeated application and release of pressure on pump 200 may fill an ear bud channel 115 with enough fluid to cause deformation of inner surface 125 and outer surface 120 of ear bud 105. In another exemplary embodiment, fluid from repeated pressurization of pump 200 may fill ear bud channel 115 and exit conduit 208 so that fluid remains within either of ear bud channel 115 or housing 101 (e.g., input conduit 206, exit conduit 208).

According to this and other embodiments of the present invention, continuous fluid input into ear bud channel 115 causes expansion of inner ear bud surface 125 and outer ear bud surface 120 such that ear bud 105 expands in size. Ear bud 105 expansion may be unidirectional or in various directions, depending on needs of the user. For example, ear bud 105 may expand over speaker 102. Alternatively, ear bud 105 may inflate to a predetermined shape. Ear bud 105 may expand to achieve a close fit between headphone 100 and the ear of a user.

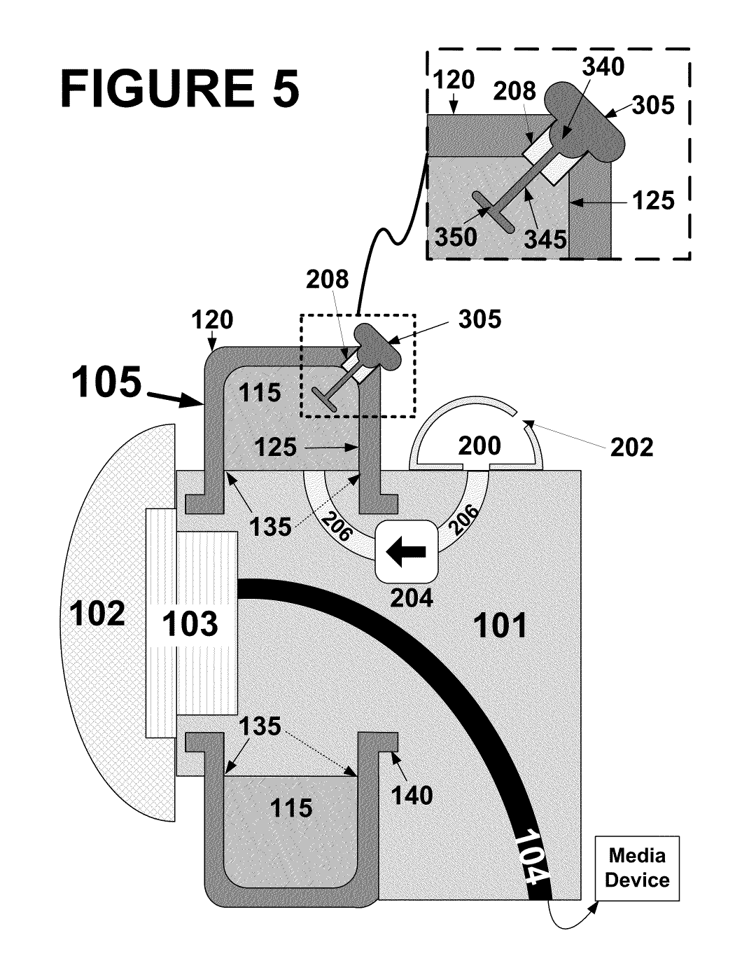

Exit conduit 208 may be manufactured and implemented in substantially the same manner as input conduit 206 described above. Exit conduit may have one or more latches 305 disposed within housing 101 or external of housing 101 to permit fluid from within exit conduit 208 to escape into the ambient. A latch 305 may be any form configured for attachment with housing 101 and may comprise flexible rubber flaps, sliding spring covers, rolling latch mechanisms or plug latches (see, for example, FIGS. 4A, 4B, 4C and 5). According to the exemplary embodiment of the present invention illustrated in FIG. 4, latch 305 is a sliding spring cover with a portion of latch 305 covering exit conduit 208 and another portion slidably engaged in a latch cavity 310 within housing 101. Disposed in, on or within latch cavity 310 is a resistance engagement between latch arm 315 and spring 320. Those skilled in the art would understand various configurations of the primary latch components may also achieve the desired result of a covering that can slide out of the path of exit conduit 208, allow fluid, e.g., air, to exit and then return to a position in which the latch covers exit conduit 208. Additionally, each and every latch 305 disclosed herein may be interchangeable with another latch 305 to extent that material permits the latch design to be implemented.

According to a different embodiment, a user of headphone 100 as depicted according to an exemplary embodiment of the present invention in FIG. 4, may press down on latch 305 to release fluid within ear bud channel 115. Although latch 305 is shown external of housing 101, the embodiments of the present invention contemplate internal arrangements of latch 305 so long as opening and closing of latch 305 may be achieved. An exemplary latch 305 internally arranged within housing 101 may be illustrated in FIGS. 4B, 4C and 5.

Referring to exemplary portions of housing 101, exit conduit 208 and latch 305 depicted in FIGS. 4A, 4B and 4C, various permutations of latch 305 may be envisioned to allow for operation of the present invention according to the disclosed embodiments herein. With reference to FIG. 4A, a latch 305 may be a flexible rubber pad which may be peeled back or propped up from the surface of housing 101 to allow fluid to exit from within exit conduit 208. According to an exemplary embodiment of the present invention according to FIG. 4A, latch 305 is a rubber or other flexible material that may be heat bonded to a surface of housing 101. Alternatively, latch 305 may be mechanically attached by screws, bolts or adhesive. Optionally, latch 305 may be configured to be moved with a single finger.

Referring to the exemplary embodiment illustrated in FIG. 4B, a rolling cylinder or sphere with tunnel 325 may be rotated by a user of headphone 100 having such housing 101 to allow a fluid link between the ambient and exit conduit 208. An exemplary latch 305 having a tunnel 325 may be incorporated into housing 101 by screws, plastic bearings, plastic axels or any other rotating mechanisms known to those skilled in the art. Rotation mechanisms such as plastic axels and plastic bearings may be situated in molded halves of housing 101 and when two such halves of housing 101 are assembled, rotating latch 305 may be operatively lodged therein. In another exemplary embodiment of the present invention illustrated in FIG. 4B, a network of miniature gears may be used to rotate latch 305 so that tunnel 325 may align with exit conduit 208. According to this exemplary embodiment, a rotating latch 305 may be situated within housing 101 so long as a gear in the network may be exposed to allow rotation of the latch 305. As previously discussed with respect to latch 305 generally, latch 305 may be operatively coupled to housing 101 both externally and internally to permit operation of the various embodiments of the present invention described herein. Optionally, rotatable latch 305 may be operated using a single finger. Optionally, a rotatable latch 305 coupled to a gear system may also be operated using a single finger.

Referring to the exemplary embodiment of the present invention illustrated in FIG. 4C, a spring-action latch 305 having a tunnel 325 and slide arm 315 coupled to spring 320 lodged in a latch cavity 310 within housing 101. As latch 305 is displaced into housing 101, spring 320 is compressed into latch cavity 310. Displacement of latch 305 may permit tunnel 325 to allow fluid to flow from exit conduit 208 out of housing 101. When latch 305 is not displaced, spring 320 may regain its original form and return latch slide 315 back to its position in the path of fluid flow from housing 101 to the ambient via exit conduit 208. An exemplary spring latch of the kind illustrated in FIG. 4C may be a latch 305 which operates within housing 101. Optionally, latch 305 may be displaced using a single finger. Alternatively, a gear system may be employed for ratcheting slide arm 315 into and out of the fluid communication passage of exit conduit 208.

Moving now to the illustrated embodiment of the present invention according to FIG. 5. FIG. 5 depicts a housing 101, audio circuitry 103, speaker 102 and ear bud 105 coupled and arranged in substantially similar fashion as in FIG. 4. Pump 200 may be placed in an operably suitable location on an exterior surface of housing 101 to pump fluid from the ambient received through passage 202 and into input conduit 206 and fill ear bud channel 115. Fluid filling ear bud channel 115 cannot exit from ear bud 105 due to a one-way valve 204, as previously described, operatively engaged with input conduit 206 to prevent fluid from within ear bud channel 115 from exiting.

According to the exemplary embodiment of the present invention illustrated in FIG. 5, exit conduit 208 may be integrally formed with or in the wall comprised of ear bud inner surface 125 and ear bud outer surface 120. Preventing fluid from escaping from ear bud 105 during inflation is a latch 305 lodged within exit conduit 208. Those skilled in the art would understand numerous ways of implementing latch 305 in conformance with the present exemplary embodiment, e.g., latches for holding in air for swimmies or floaties, plugs for holding water in toy water guns. Alternatively, a suitable latch 305 may be any small capping mechanism which may close the passage of fluid from ear bud 105.

Depicted at a closer vantage point in FIG. 5 is latch 305 lodged within exit conduit 208 within outer ear bud surface 120 and inner ear bud surface 125. Latch 305 comprises a plug 340 which frictionally fits within exit conduit 208. Stem 345 extends from plug 340 to anchor 350 which keeps latch 305 coupled to ear bud 105. In another aspect of the exemplary embodiment according to FIG. 5, latch 305 may be a flexible flap adhesively or molded to ear bud outer surface 120 similar to latch 305 depicted in FIG. 4A. Like latch 305 of FIG. 4A, a user may open up exit conduit 208 to the ambient, permitting release of all fluid within ear bud channel 115. Latch 305 may be resilient enough to resist opening during expansion of ear bud 105, but pliable enough to be opened by the user when seeking to deflate ear bud 105. Those skilled in the art will understand the materials suitable to allow ear bud 105 latch 305 to accomplish this task according to this aspect of the illustrated embodiment of FIG. 5. For example, latch 305 may be a vulcanized rubber flap heat-bonded to surface 120 of ear bud 105. Vulcanized rubber flap latch 305 may have enough rigidity to avoid being displaced by fluid collected within ear bud channel 115 during inflation, but which is flexible enough to be moved away to deflate ear bud 105 using a single finger of a user to flip or bend it out of the path of exit conduit 208.

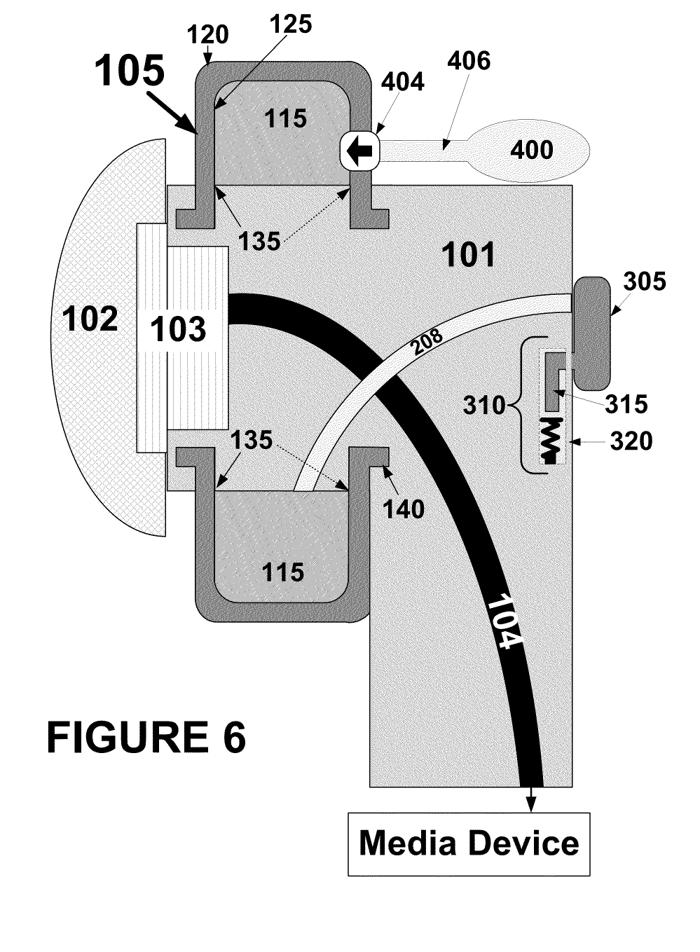

With reference to FIG. 6, another illustrative embodiment of the present invention may be seen with headphone housing 101 coupled to audio circuitry 103 in communication with speaker 102 and with electrical connection 104 to a media device (not shown). While an ear bud 105 with outer surface 120 and inner surface 125 forming a wall with portions 140 for engaging housing channels 135 is shown, the exemplary embodiments of FIG. 6 contemplate numerous other ear bud 105 and housing 101 arrangements according to other embodiments of the present invention. Exit conduit 208 resembles the exit conduit 208 depicted in FIG. 4 and carries with it all permutations discussed with respect to the same (e.g., FIGS. 4A, 4B and 4C). FIG. 6 further illustrates an exemplary direct pump device 400 coupled to a one-way valve 404 integrated with the wall formed by outer ear bud surface 120 and inner ear bud surface 125. Ear bud channel 115 receives fluid through one-way valve 400 via chamber 406. An exemplary direct pump device 400 may be a flexible rubber bubble similar to an eyedropper. Those skilled in the art would understand other forms of direct pump devices to achieve the desired objectives described herein with respect to the exemplary embodiment of FIG. 6.

In one embodiment, fluid, for example, air, pumped from direct pump device 400 is channeled through chamber 406 to a one-way valve 400 similar in like and kind to one-way valve 204 described in other embodiments of the present invention. One-way valve 404 may be molded into or mechanically coupled to ear bud 105 by any number of ways known to those skilled in the art. As fluid is administered to ear bud channel 115 from direct pump device 400, ear bud 105 expands to a larger size. A direct pump device 400 according to the various embodiments of the present invention may be interchangeable with pump 200 and may alternatively be permanently or removably attached to housing 101 and/or a surface of ear bud 105. To deflate an expanded ear bud 105 according to the exemplary embodiment of FIG. 6, a user may resort to a sliding latch 305 as previously discussed in FIGS. 4, 4B and 4C. Alternatively, a plug latch 305 of the type described in FIG. 5 may also be employed.

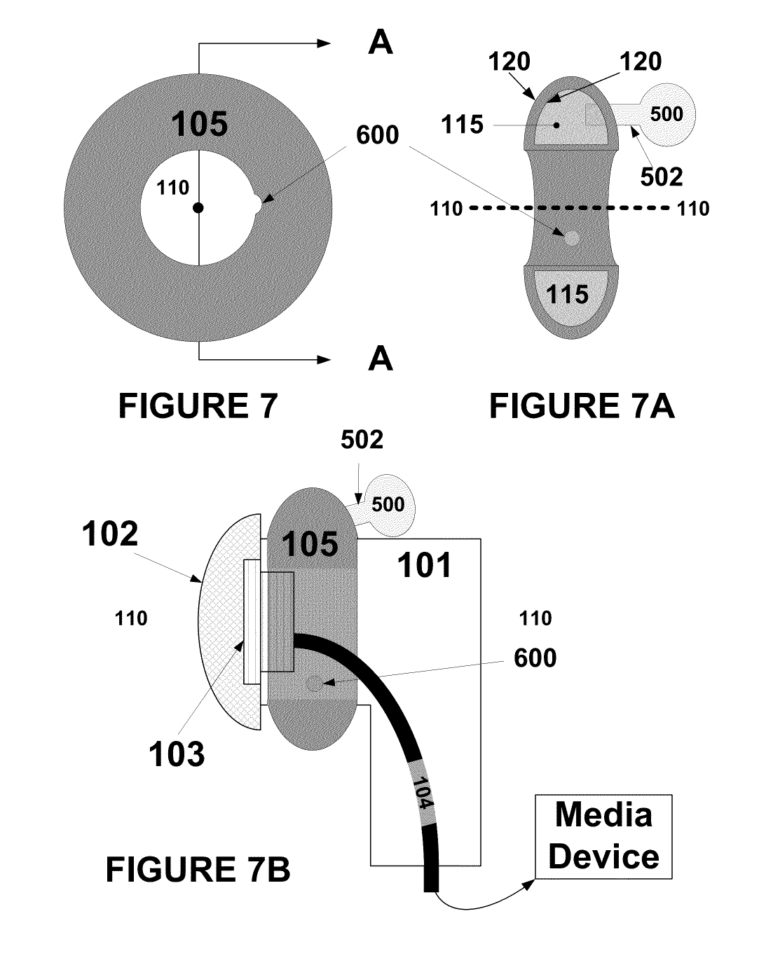

According to the exemplary embodiment of the present invention illustrated in FIG. 7, an ear bud 105 may be shaped in a substantially doughnut-like shape about an axis 110. The topographical view of the ear bud 105 shown in the illustrative embodiment of FIG. 7 has a void 600 in its inner-most surface, e.g., the surface that may contact housing 101. Although ear bud 105 is shown as a substantially round shape in FIG. 7, ear bud 105 may be a shape that is mostly square, an octagon or an amorphous shape. Further, ear bud 105 may be amorphous to permit optimal fixation within a user's ear or ear canal, e.g., molded for specific medical uses, support of handicaps.

With reference to FIG. 7A, a side view of one-half of the ear bud 105 is shown. Below the central axis through ear bud 105 is void 600, a space in ear bud 105 made by any known means in the art. Void 600 may be of any form or shape to accomplish the results described herein. In addition to void 600, ear bud 105 further includes a direct pump 500 similar to type and construction of direct pump 400 in FIG. 6. However, according to the exemplary embodiment of the present invention illustrated by FIG. 7A, direct pump 500 has no one-way valve mechanism or other device intervening between pump housing 500, pump chamber 502 and ear bud channel 115. Direct pump 500 may be manufactured to be substantially the same as direct pump chamber 400 or as other pumps suitable for the purposes of providing fluid into ear bud 105. However, according to the exemplary embodiment of FIG. 7A, inflation of ear bud 105 may not substantially go to completion until ear bud 105 is coupled to headphone housing 101 when void 600 is large enough to permit passage of fluid from ear bud channel 115 to the ambient. Otherwise, where void 600 is air tight, e.g., does not allow fluid to exit from ear bud channel 115 to the ambient, ear bud 105 may be inflated to completion before, during or after coupling to housing 101.

FIG. 7B shows an exemplary coupling arrangement between headphone 100 and inflatable ear bud 105. A headphone housing 101 connected operatively to speaker 102 and audio circuitry 103 engages a media device by way of an electrical connection of wire 104. In one aspect of the exemplary embodiment of FIG. 7B, inflatable ear bud 105 may be slipped on, wrapped on or molded onto a receiving surface of housing 101. An exemplary receiving surface of housing 101 may contain a ledge, prong or other housing 101 surface structure configured to substantially fill void 600. In this way, housing 101 surface structure may frictionally couple inflatable ear bud 105 to housing 101. In another aspect of the exemplary embodiment of FIG. 7B, housing 101 surface structure may also serve as a plug for void 600 where void 600 permits passage of fluid from ear bud channel 115 to the ambient. Void 600 serves as a mechanical coupling of ear bud 105 to housing 101 and a latch to restrict passage of fluid from ear bud 105. Direct pump 500 and pump chamber 502 may be situated anywhere about housing 101. In an exemplary housing 101, housing 101 may have a receiving surface configured to nestle direct pump 500 and/or pump chamber 502. Such a receiving surface may allow additional coupling stability to the inflatable ear bud 105 embodiment of FIGS. 7, 7A and 7B while also making a sleeker headphone 101 exterior. An exemplary receiving surface may be a groove in which direct pump 500 sits within with a complementary groove for pump chamber 502, each molded into housing 101 of the headphone 100.

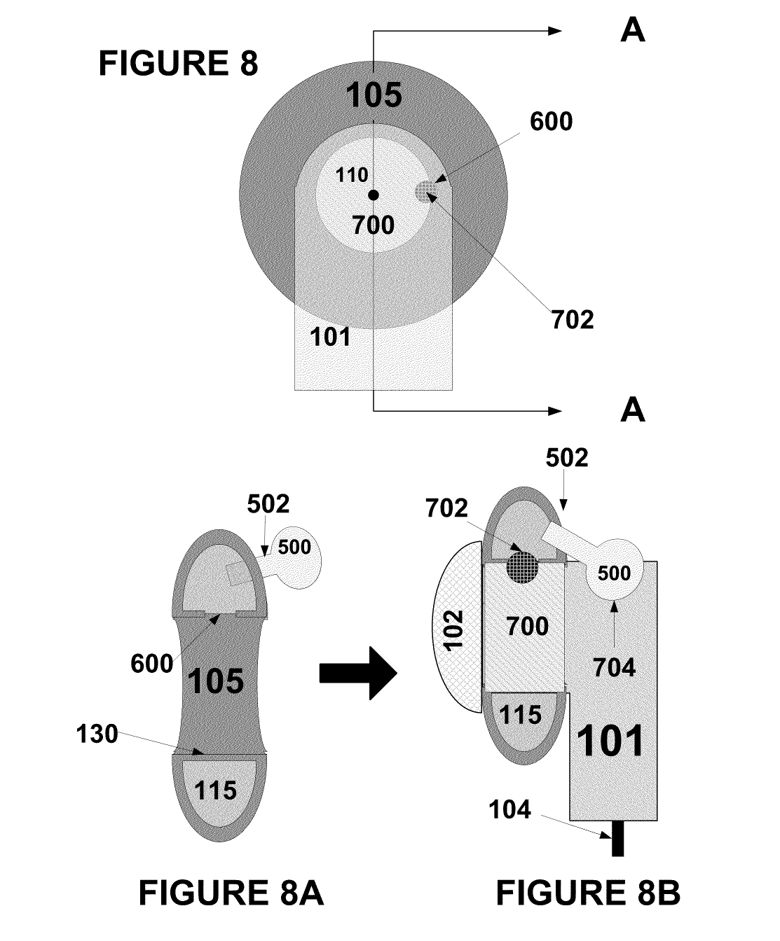

Turning now to FIG. 8 which illustrates another exemplary embodiment of the present invention, a rear view of the headphone with inflatable ear bud system may be seen with the back of housing 101 in the foreground. Between the background ear bud 105 and foreground housing 101 is housing 101 receiving surface 700. An exemplary housing receiving surface 700 may be any grooved or patterned surface created by molding, etching or other forms of material modeling that increases the contact between inner axial wall 130 of ear bud 105 and housing 101. An exemplary receiving surface 700 may be a pattern of triangular teeth which receive complementary sized rubber teeth extending axially from axial wall 130 towards the center of inflatable ear bud 105. According to the exemplary embodiment of FIG. 8, housing 101 receiving surface is located about axis 110. However, those skilled in the art will understand that receiving surface 700 may be any number of surfaces to accommodate a corresponding ear bud under the needs and circumstances of a user. Further illustrated in FIG. 8 is void 600 made in ear bud 105. A complementary housing 101 surface structure 702 is illustrated as well. Surface structure 702 may be a component of same or different material to housing 101 and may likewise be integrated with, separately adhered to or otherwise coupled to housing 101.

The cross section of FIG. 8 may be exemplified with reference to FIGS. 8A and 8B. In FIG. 8A, an exemplary inflatable ear bud 105 is shown with void 600 made in what has been heretofor identified as ear bud axial wall 130. Further illustrated is direct pump 500 with pump chamber 502. Although direct pump 500 is shown, the illustrative embodiment of FIG. 8A contemplates any and all disclosed direct pumps or pumping mechanisms of similar function, methodology and capable of achieving like results. FIG. 8A may also be interpreted to show a “C” shaped ear bud 105 to snap onto a housing 101. Ear bud 105 need not be “C” shaped for the purposes of the operation of the embodiments exemplified by FIGS. 8, 8A and 8B.

The cross section of FIG. 8 may be seen more fully in FIG. 8B. According to the exemplary illustration of the present invention according to FIG. 8B, inflatable ear bud 105 is situated about receiving surface 700 of housing 101. An exemplary receiving surface may be located anywhere on or between speaker 102 and wire 104, although those skilled in the art may recognize that speaker 102 may, in certain cases, serve as a receiving surface. Thus, for the purposes of the exemplary embodiment of FIG. 8B, receiving surface 700 is found between speaker 102 and the exposed portion of housing 101. Additionally, housing 101 has extension 702 and pump receptacle 704 configured to hold pump 500 and/or pump chamber 502. Extension 702 may be sized and situated to plug or seal any opening in ear bud 105 axial wall 130. Pump receptacle 704 may be sized and shaped to limit movement of direct pump 500 and/or pump chamber 502. An exemplary direct pump 500 may be friction fit into receptacle 704, although other forms of reception in housing 101 may be recognized by those skilled in the art. An exemplary receptacle 704 for pump chamber 502 may be a hook or other over-hanging structure which allows housing 101 to better secure ear bud 105 to the housing 101 surface. Although the embodiments illustrated in FIGS. 8A and 8B depict a void through which fluid may exit ear bud channel 115, those skilled in the art will understand that these illustrative embodiments include those ear bud axial walls with voids 600 that do not transmit fluid from ear bud channel 115 to the ambient.

A user of an inflatable ear bud system incorporating an inflatable ear bud as illustrated and described in any of the disclosed embodiments, may make use of the device assembly in various manners. A first method of using the inflatable ear bud system is to affix the inflatable ear bud to the housing of the headphones by one or more of the following: slipping the flexible hollow ear bud over the speaker, slipping the headphone wire through the open center of the ear bud and sliding the ear bud up and around the headphone housing so as to bring the ear bud to the desired housing surface, or flexibly expanding ear bud to fit over one or more of the speaker and/or housing to maintain a close fit. The ear bud may be partially or fully filled with fluid prior to assembly to the housing 101 of the headphone. Upon establishing a connection to housing 101, a user may place ear bud 105 into the location in the user's ear in which sound will be heard.

In one aspect, a user's thumb and middle finger hold housing 101 with inflatable ear bud 105 in place, while a user may use his or her index finger to begin contacting a pump affiliated with ear bud 105. For the purposes of this example, the index finger may be used to repeatedly press direct pump 400. While the user proceeds to inflate the ear bud to increase the degree of ear bud contact and minimize outside noise interference within the user's ear, a point will be reached when either the user's ear cannot receive any further increases in ear bud size or the ear bud has reached its maximum inflation size. Once completed, the ear bud 105 may be deflated by simply removing the pump, removing the ear bud or pressing a relief switch on housing 101.

In another aspect, a user may already receive a housing 101 with inflatable ear bud 105 attached thereto. Upon placing ear bud within a cavity of the user's ear, a user may use one of his or her fingers to activate inflation means disposed on the housing 101 or inflatable ear bud 105 to create a substantially tighter fit between the ear bud 105 and the user's ear.

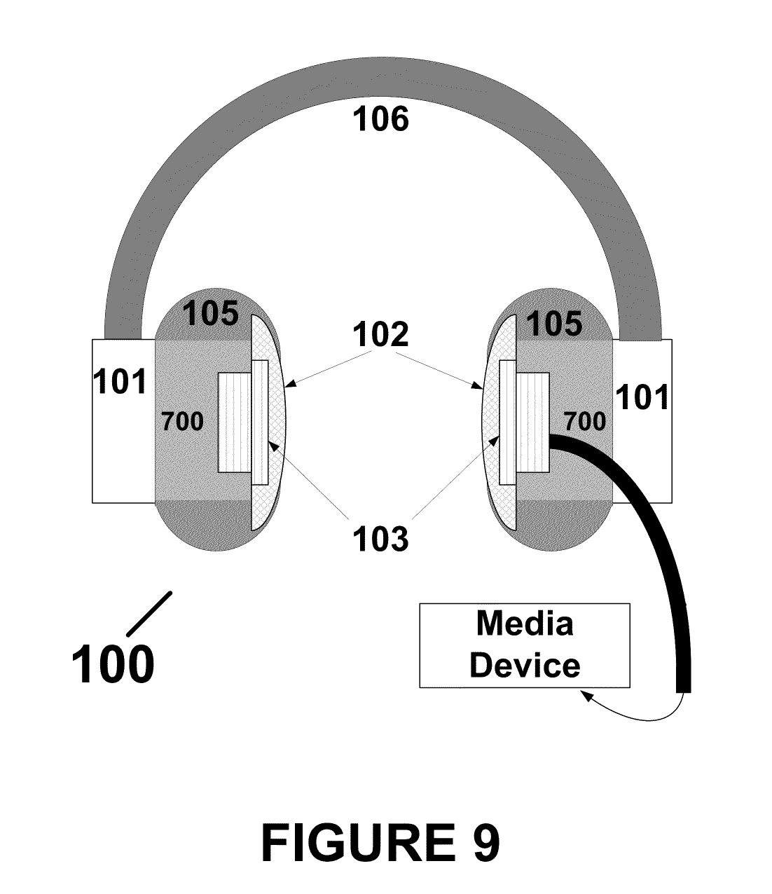

When a user wishes to remove the ear bud 105 deployed as previously described in the above disclosures and methods, user may utilize one or more means disposed on either of ear bud 105 or housing 101 to permit fluid to escape from ear bud channel 115 back out to the ambient.

Where headphone 100 is a headset headphone, as in FIG. 9, ear bud 105 may engage both housing 101, receiving surface 700 and speaker 102 since headset headphones have speakers located within the speaker material. According to this example, inflatable ear bud may inflate around user's ear rather than within a cavity formed by the user's ear, e.g., the ear bud 105 balloons about the periphery of user's ear to substantially reduce noise loss and/or outside interference to transmission of sound from a media device. In this particular example headphone 100 may be configured according to headset headphone constructions known to those skilled in the art.

In the exemplary embodiment according to the illustration in FIG. 9, headset headphones 100, may have two substantially identical headphone housings 101 comprising one or more of the inflation and deflation mechanisms described herein, e.g., input conduits, pumps, latches and/or plugs. Alternatively, headset headphone 100 may comprise ear buds 105 with one or more of the inflation and deflation mechanisms described herein, e.g., latches, pumps (direct and otherwise) and/or plugs. Housing receiving surface 700 may also comply with one or more of the disclosures related to the same described herein. For example, receiving surface 700 may be configured to frictionally fit a headset headphone ear bud 105. Alternatively, receiving surface 700 may be mechanically coupled to ear bud 105 via adhesives, heat bonding, complementary shape engagement (e.g., for ear buds with portions 140 and housings 101 with channels 135) and/or any other form of coupling known to those skilled in the art. Optionally ear bud 105 may engulf speaker 102. However, embodiments where speaker 102 protrudes from ear buds 105 are also permissible. It may be that user may take two in-ear headphones 100 and connect them via a bridge 106 to form a headset headphone 100 as shown in FIG. 9. According to this example, ear buds 105 may Optionally not engulf speaker 102. However, in any of the various embodiments, ear bud 105 may be configured to inflate to fit the cavity of a user's ear or the space surrounding the periphery of a user's ear.

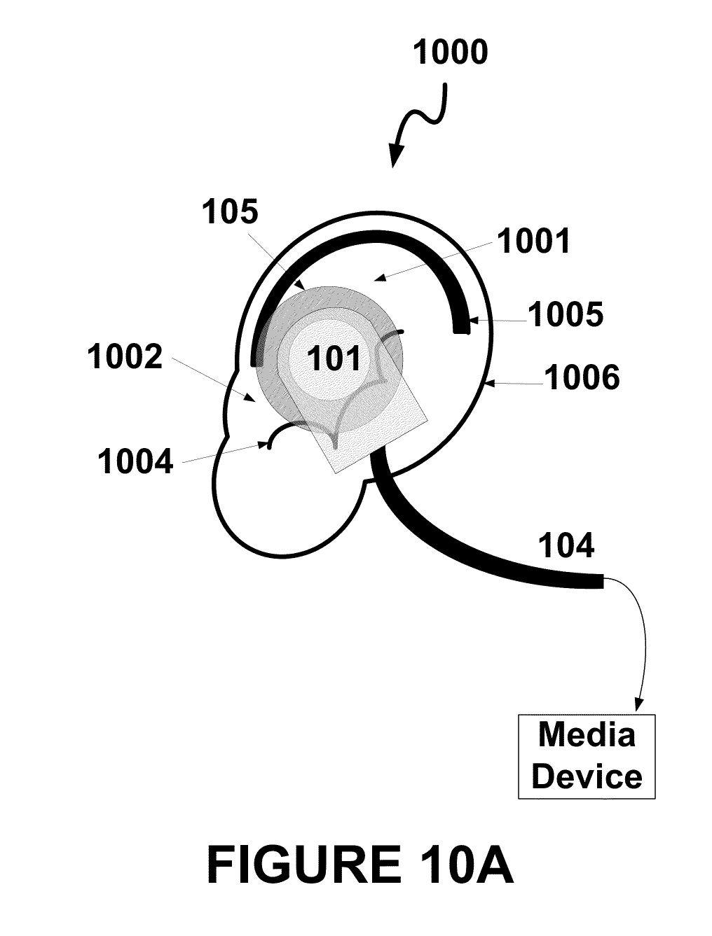

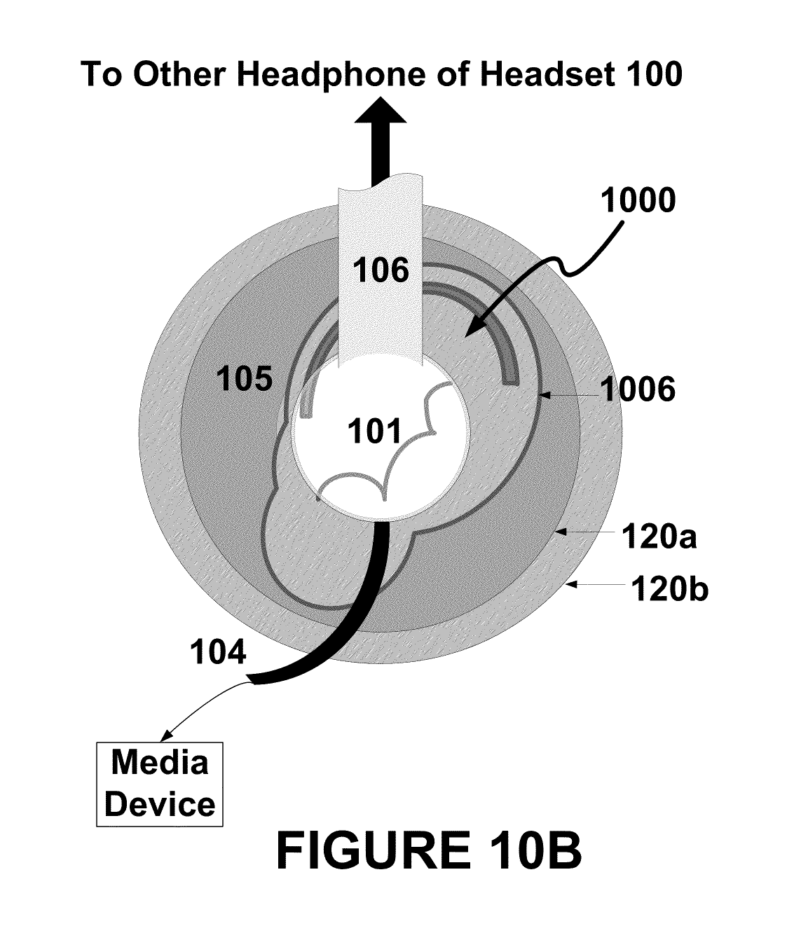

Referring to the exemplary embodiment of FIG. 10A, a headphone 100 comprising housing 101, wire 104 to media device (media device not shown) and ear bud 105 may be found within the ear 1000 of a user. Ear bud 105 may be located approximately within a space within user ear 1000 defined by upper ear lobe 1001 and lower earlobe 1002. While ear bud 105, according to the exemplary embodiments of the present invention herein described, may be inflated to substantially fit in the space defined by upper ear lobe 1001 and lower earlobe 1002. Alternatively, ear bud 105 according to the exemplary embodiments of the present invention herein described, may be inflated to substantially fit within a space defined by a combination of upper ear lobe 1001, lower earlobe 1002, upper lobe fold 1005 and lower lobe fold 1004. Optionally, ear bud 105 may be situated within lower lobe fold 1004 and expanded by a user to inflate ear bud 105 surface until sufficient contact is made with one or more of upper earlobe 1001 or upper lobe fold 1005. Those skilled in the art may recognize the upper and lower earlobes and folds may differ from user-to-user and such variations do not limit the scope and spirit of the present invention's application to such unique ear anatomies. Alternatively to any of the aforementioned, ear bud 105 may be situated within an ear canal (not shown). According to this alternative exemplary embodiment, inflation of ear bud 105 may not engage upper lobe fold 1005 or lower earlobe 1002, but may sustain contact with ear 1000 merely by virtue of its situation in the ear canal. However, a user may inflate ear bud 105 in accordance with embodiments discussing inflation into any portions of ear 1000 (e.g., upper lobe 1001, upper lobe fold 1005, lower lobe 1002, lower lobe fold 1004) even when ear bud 105 engages the ear canal of ear 1000 of a user.

It may also be recognized in FIG. 10A, that while ear bud 105 may engage certain portions of ear 1000, speaker 102 (not shown) may engage different portions of ear 1000. For example, speaker 102 may engage ear canal while ear bud 105 engages the combination of lower lobe fold 1004 and upper lobe fold 1005. Alternatively, speaker 102 may be spaced from a surface of ear 1000 while ear bud 105 creates a closed cavity containing the same by virtue of its contact with upper lobe 1001 and lower lobe 1002 of user ear 1000. Housing 101 may also engage portions of user ear 1000 either alone or in combination with speaker 102 and/or ear bud 105. In a different embodiment, housing 101 may engage lower lobe fold 1004 while ear bud 105 engages lower lobe 1002 and either of upper lobe 1001 or upper lobe fold 1005. In another different embodiment, housing 101 may engage a periphery 1006 of ear 1000 while ear bud 105 engages lower lobe 1002 and either of upper lobe 1001, lower lobe fold 1004 or upper lobe fold 1005. Depending on the shape and sizing of ear bud 105 and user ear 1000, any exemplary ear bud 105 may engage one or more different combinations of the user ear 1000 to achieve the beneficial aspects herein described.

Turning to the exemplary embodiment of the present invention as illustrated by FIG. 10B, a user ear 1000 may be situated between a headset headphone 100 comprising a housing 101, a bridge 106 to a second housing (not shown), a wire 104 to a media device (not shown) and an ear bud 105. Ear 1000 is found underneath the exterior surface 120b of ear bud 105. According to the illustrative embodiment of FIG. 10B, an interior surface 120a of ear bud 105 is proximal to ear periphery 1006 such that ear bud 105 substantially reduces noise coming between speaker 102 (not shown) and ear 1000 or reduces interference with signals provided by media device (not shown) connected via wire 204. An exemplary ear bud 105 according to the embodiments described and FIG. 10B may be shaped so that its expanded state provides interior surfaces 120a which advantageously couple in or around ear periphery 1006. For example, ear bud 105 may inflate to wrap about periphery 1006 of ear 1000 to reduce disruptions of sound provided from a media device. Those skilled in the art will understand that a bridge 106 may be configured to assist in the inflation and tight coupling of ear bud 105 of a headset headphone 100 to ear 1000 of a user. For instance, headset 106 may be rigid so as to tightly hold inflated ear bud 105 in a more proximal relationship to periphery 1006 of ear 1000.

It should be understood that the headphone 100 or headset headphone 100 of either of FIG. 10A or 10B may be configured, operated and otherwise utilized in accordance with any of the embodiments previously disclosed, in any form or combination. As previously stated, any and all embodiments may be interchangeable depending on the needs of the particular user.

While the invention has been described by way of example embodiments, it is understood that the words which have been used herein are words of description rather than words of limitation. Changes may be made, within the purview of the appended claims without departing from the scope and the spirit of the invention in its broader aspects. Although the invention has been described herein with reference to particular structures, materials, and embodiments, it is understood that the invention is not limited to the particulars disclosed.

What is claimed is:

1. A wearable sound emitting device, comprising:
a speaker;
an audio circuit configured to generate sound from a media device;
an inflatable, flexible mount comprising an exterior surface and an interior surface, wherein at least one conduit between said interior surface and said exterior surface permits transmission of a fluid;
means to inflate said mount;
a housing configured to receive at least a portion of said exterior surface of said mount and configured to receive said means to inflate said mount, wherein said housing couples said speaker to said audio circuit and couples said conduit of said mount to said means to inflate said mount.

2. The mount of claim 1, wherein said mount has a substantially toroidal shape.

3. The mount of claim 1, wherein said mount has a circular shape.

4. The device of claim 1, wherein said housing receives at least a portion of said interior surface of said mount.

5. The device of claim 1, wherein said means to inflate said mount comprise a pump disposed on said housing and connected via a tunnel through said housing to said conduit.

6. The device of claim 5, wherein means to provide unidirectional flow of fluid to said mount is coupled to said tunnel.

7. The device of claim 1 further comprising means to deflate said mount coupled to said conduit.

8. The device of claim 7, wherein said means to deflate said mount comprise a flexible latch.

9. The device of claim 7, wherein said means to deflate said mount are connected to at least another conduit between said interior and said exterior surfaces of said mount.

10. The device of claim 9, wherein said means to deflate said mount comprise a flexible latch.

11. A wearable sound emitting device, comprising:
a speaker;
an audio circuit configured to generate sound from a media device;
an inflatable, flexible mount comprising an exterior surface and an interior surface, wherein at least one conduit between said interior surface and said exterior surface permits transmission of a fluid;
means to inflate said mount coupled to said conduit;
a housing configured to receive at least a portion of said exterior surface of said mount and configured to receive said means to inflate said mount, wherein said housing couples said speaker to said audio circuit.

12. The mount of claim 11, wherein said mount has a substantially toroidal shape.

13. The mount of claim 11, wherein said mount has a circular shape.

14. The device of claim 11, wherein said housing receives at least a portion of said interior surface of said mount.

15. The device of claim 11, wherein said means to inflate said mount comprise a pump disposed on said mount and connected via a tunnel to said conduit.

16. The device of claim 15, wherein means to provide unidirectional flow of fluid to said mount is coupled to said tunnel.

17. The device of claim 11 further comprising means to deflate said mount coupled to said conduit.

18. The device of claim 17, wherein said means to deflate said mount comprise a flexible latch.

19. The device of claim 17, wherein said means to deflate said mount are connected to at least another conduit between said interior and said exterior surfaces of said mount.

20. The device of claim 19, wherein said means to deflate said mount comprise a flexible latch.
